(19) United States
(12) Patent Application Publication
(10) Pub. No.: US 2006/0125846 A1
(43) Pub. Date: Jun. 15, 2006

(54) Virtual overlay for computer device displays

(76) Inventors: Gregory T. Springer, Dallas, TX (US); Matthew G. Diaz, Dallas, TX (US)

Correspondence Address: TEXAS INSTRUMENTS INCORPORATED, P O BOX 655474, M/S 3999, DALLAS, TX, 75265, US

(21) Appl. No.: 11/010,164

(22) Filed: Dec. 10, 2004

(51) Int. Cl. G09G 5/00

(52) U.S. Cl. 345/629

(57) ABSTRACT

A method of teaching with computer devices having displays. Virtual transparent overlays and underlays are generated that can be annotated with indicia such as words, marks, and other selected indicia. Alternately, or in combination with a transparent overlay as discussed above opaque overlays can be generated for selected uncovering of information available on a computer device display.

### TECHNICAL FIELD

The present invention relates to a teaching method for use with computing devices having associated displays, and more specifically to such methods for use in an actual classroom or a virtual classroom wherein each student has access to a computing device and associated display.

### BACKGROUND

Teaching in a classroom has, for sometime, often included the presentation of information by means of a system for projecting images onto a display screen. Typically the screen is an ordinary projection screen for receiving front projected images or a light colored wall. As a teaching method, the information on an original image transparency was typically either annotated by writing or marking on the original image transparency or by placing another transparency or “overlay” that only included the annotations over the first transparency. Alternately information on the original image transparency could be selectively displayed information by the use of an opaque overlay placed in position on top of the transparency. Often, the teacher would simply use a blank sheet of paper to cover all or part of the projected image. The teacher would then move the opaque sheet to selectively reveal or hide parts of the projected image.

Many modern classrooms now use television or computer generated images that are displayed by a projection system or upon a student's personal visual display as a teaching medium.

Therefore, it would be advantageous to use the teaching concepts of projected annotated transparencies and opaque overlays with the new teaching tools of computer displays and computer generated images.

### SUMMARY OF THE INVENTION

The method of the present invention provides annotations of an image on a displayed image or alternately a selective display of portions of the image.

More specifically, the invention comprises the steps of providing or generating a selected image for displaying on a display device. In addition to the selected image, the computing device also generates a virtual image overlay or an underlay for the selected visual image. The selected image and the virtual image (overlay or underlay) are displayed on the display device to form a composite image. Accordingly, the appearance of the virtual image overlay may then be selectively altered by the computing device such that the composite image is changed. According to one embodiment, the virtual image overlay is a virtual transparent overlay wherein the step of altering the appearance of the overlay comprises the step of generating visible indicia on the virtual transparent overlay to annotate the selected image. The transparent overlay may be annotated in any suitable manner including the addition of words or phrases, highlighting, or the addition of arrows, marks, and other symbols.

According to another embodiment, the user may select one or more objects, images, paragraphs of text, etc. generated by a computer program or application, and provide these selected items to the computer display as an “underlay”.

Alternately, the virtual overlay may be a virtual opaque overlay that appears to cover selected portions of the selected underlay image. The opaque overlay is then altered by cutting or defining apertures or openings in selected portions of the opaque overlay to reveal the information on the selected image that is below the openings. The openings or apertures cut into or generated into the virtual opaque overlay may be generated at one time or sequentially such that the information is displayed at different times.

It should also be appreciated that more than one underlay or more than one virtual transparent or opaque overlays may be generated for annotation. Thus one overlay (or underlay) could include annotations by the instructor or teacher and the other overlay could include annotations by a student. It will further be appreciated that the virtual transparent overlays could include a portion of an opaque overlay such that both techniques are used. According to another embodiment rather than a single display, the system may also be used wherein each individual student has their own computing device and display and the instructor has a second display that is different from that of the students. It will be appreciated of course that the teacher's display will often include significantly more information than the students display, and such that the material available to the teacher can be displayed in sequence to the student, or at any time the teacher chooses.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a block diagram of a computing device and display system suitable for use with the present invention;

FIG. 2A illustrates an exploded view of a selected image to be annotated and a transparent virtual image overlay with an annotation;

FIG. 2B illustrates a composite view of the selected image and the virtual image overlay of FIG. 2A with annotation marks;

FIG. 3A illustrates an exploded view of a selected image to be annotated and two transparent virtual image overlays with annotations;

FIG. 3B illustrates a composite view of the selected image and the two virtual image overlays of FIG. 3A, each having annotation marks;

FIG. 4A illustrates an exploded view of a selected image and a virtual opaque overlay;

FIG. 4B illustrates a composite view of the selected image and the virtual image opaque overlay of FIG. 4A as displayed on a secondary or student display device;

FIG. 4C illustrates a composite view of the selected image and the virtual opaque overlay of FIG. 4A or master or teacher's display device;

FIG. 5 illustrates a classroom using the teaching device of the present invention;

FIG. 6A illustrates the same exploded view of FIG. 3A except that an opening or aperture has been defined in the opaque portion of the virtual opaque overlay;

FIG. 6B illustrates a composite view of FIG. 4A as displayed on the secondary or student display device;

FIG. 6C illustrates a composite view of FIG. 4A as displayed on the master or teacher's display device;

FIG. 7 illustrates a network setup suitable for using another embodiment of the present invention; and

FIG. 8 illustrates a network classroom setup suitable for using a third embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

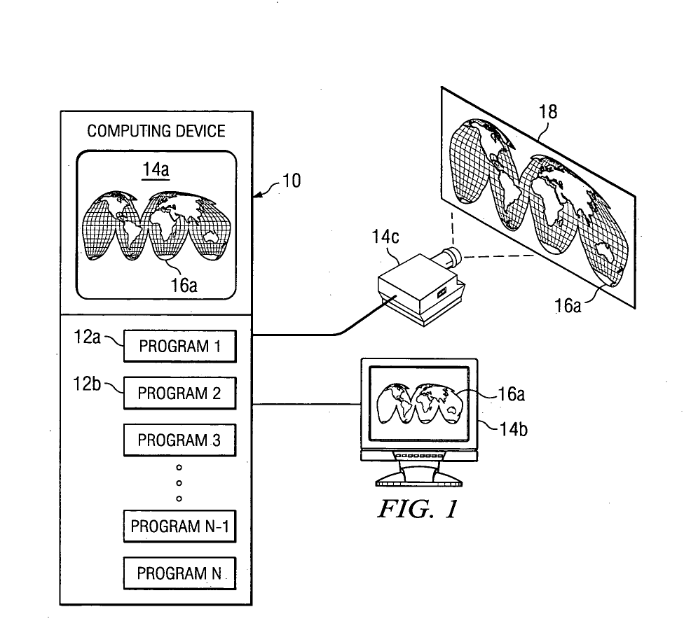

Referring now to FIG. 1, there is shown a computing device such as a personal computer, a laptop computer, or another handheld computing device 10. The computing device 10 will typically have an array of programs available, which generate selected images on a display device. The various selected programs are indicated as program 12a-12n. The display device may be the screen 14a of a laptop or hand held device, the monitor 14b for a PC, or a projection device 14c that receives an input from the computing device and actually projects an image 16a generated by a first program 12a onto a projection screen 18 or a light colored wall (not shown). In addition to generating the image 16a or first image generated by the first program 12a, according to the present invention, the computing device also includes a second program for generating virtual overlays that lie over the image 16a created by the first program 12a. The virtual image overlay program is indicated by reference numeral 12b.

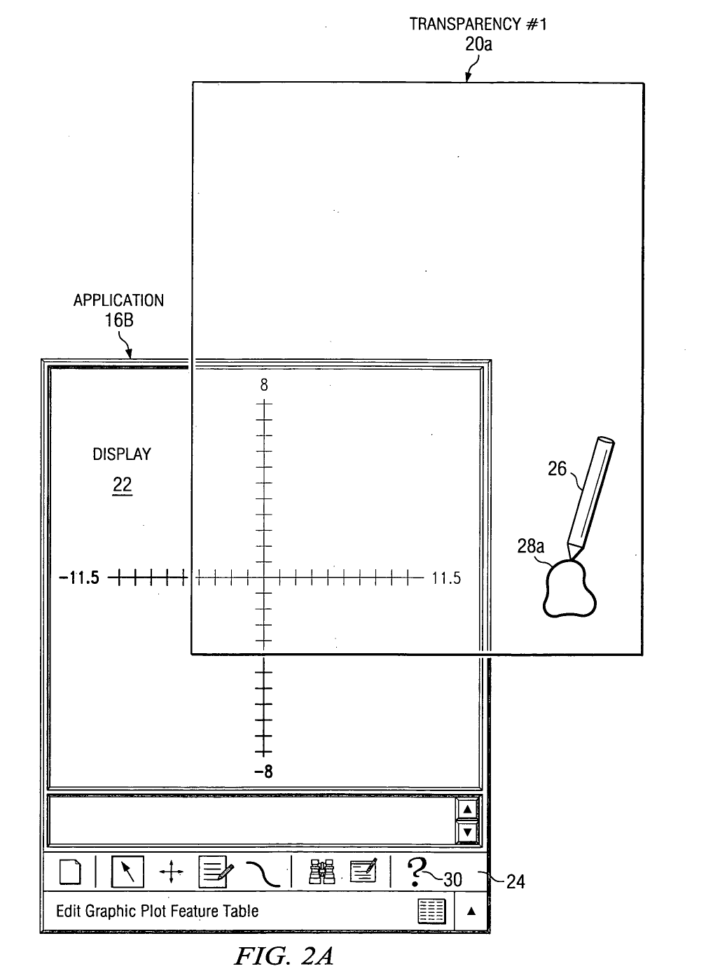

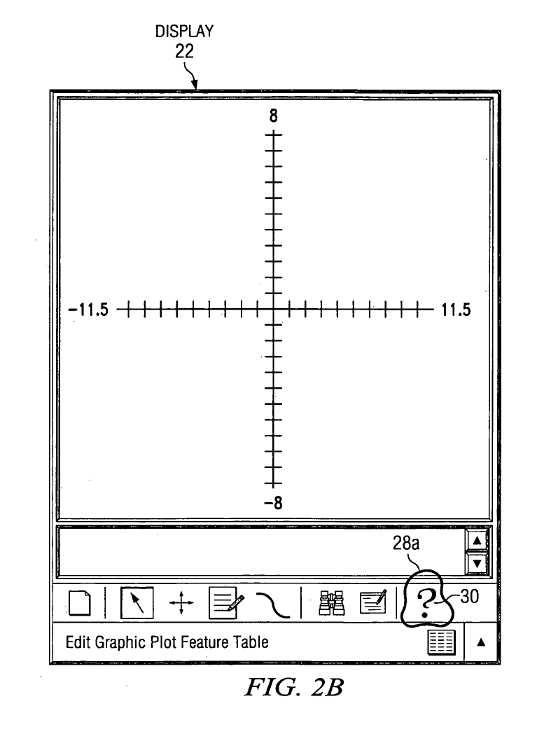

Referring now to FIG. 2A, there is indicated an exploded view portion of another selected image 16b as generated by the first program 12a. Also shown as a part of the exploded view of FIG. 2A is the virtual transparent image overlay 20a also generated by the computing device 10 in response to the virtual overlay program 12b. The virtual transparent overlay may also include a “tool kit” that includes pens, marks, highlighting, paintbrushes, and so forth that can be used to generate marks and annotations on the transparent overlay 20a.

Therefore, as shown on the selected image 16b there may be included a display area 22 such as is often shown on a graphing calculator or other computer device for teaching mathematical theories and processes. In addition to the display area 22, the selected image may also include a section or tool bar portion 24 or entry area for entering formulas and equations to be used as the source of graphs created on the display area 22. Thus, if in the teaching process the instructor wants to point out the use of a particular function in the tool bar area 24 of the selected image 16b, he may use tinting or selected shapes such as circles or rectangles to enclose a particular function and tool bar. Alternately, he may use a virtual pen or stylus 26 to draw an enclosure 28a or otherwise highlight the area of the transparency 20a that overlays the function or icon 30 that the instructor wishes to bring to the attention of the students. Other indices such as arrows, check marks, hand silhouettes, starts, pointers, underlines, and letters of the alphabet may also be used. Therefore referring to FIG. 2B, the composite display of the transparency 20a and the selected image 16b is seen to include the enclosure 28a around the icon of the selected function. It will be appreciated that the transparency overlay 20a is not actually displayed as being separate and offset from the selected image 18 as shown in FIG. 2A but, actually is displayed on both the students' and the teacher's displays as the computed display or image of FIG. 2B. It should also be understood, however, that the annotation to the display in FIG. 2B is only on the virtual transparency 20a, and in no way affects the actual first program 12a in the computer. That is, only the annotations change the virtual image overlay display program 20a. This annotated transparency can then be stored as a file in the computing device 10 if desired or other similar transparencies with other annotations may be stored as well for the same selected image 16b. Thus it is seen that the effect of this virtual image 20a is similar to that of the teaching technique of using overhead projectors and annotating the transparency used to project selected images. However as was stated above, the annotation in no way alters the first program 12a that presented and generated the selected image 16b. The application or program that generates the image 16b has no interaction with the overlay (or underlay).

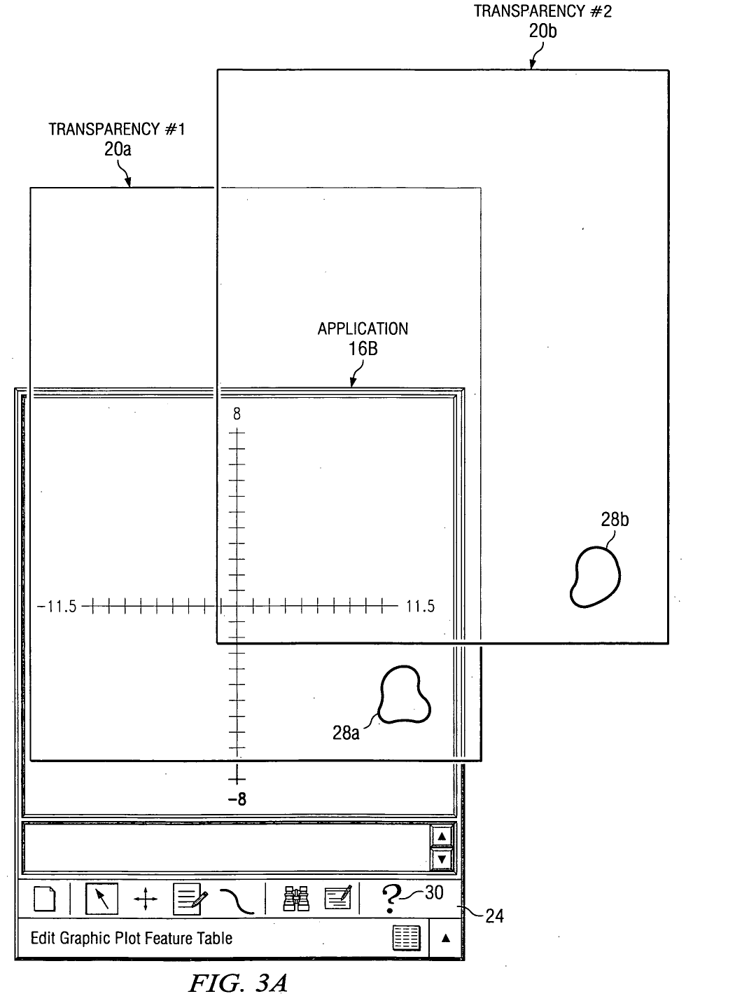

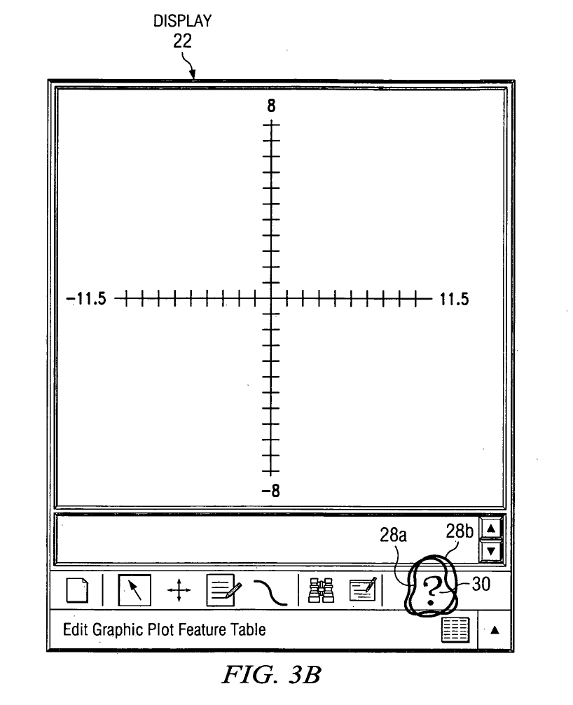

Referring now to FIGS. 3A and 3B, there is shown another embodiment of the present invention that includes a second transparency image 20b that may be used to generate different annotations 28b than those annotations generated on the first transparent overlay 20a. It will be appreciated that the use of different line widths or styles and different colored annotations 28b will help distinguish between the annotations on the second transparency 20b and the annotations on the first transparency 20a. FIG. 3B displays the composite image formed by the selected image 16b and the two transparency overlays 20a and 20b. As was also discussed above, it will be appreciated that both the virtual transparency overlays 20a and 20b may each be stored separately and could represent different aspects of the teaching lesson, or the performance or contributions of different students, etc. It should also be appreciated that the virtual transparency overlays are not limited to two but could be any number including one for each of the students in a class.

In an alternate embodiment that is similar to generating an overlay, the present invention may also be used to generate an “underlay”. Unlike an “overlay”, to generate an underlay, the user selects one or more objects such as text, images, dynamic geometry objects, etc from the original image or program 1 that are copied to the underlay for later review or study. For example, key sentences of long paragraphs could be sent to a summary sheet underlay, or a student's notes could be collected while reading an e-book or other electronic communication.

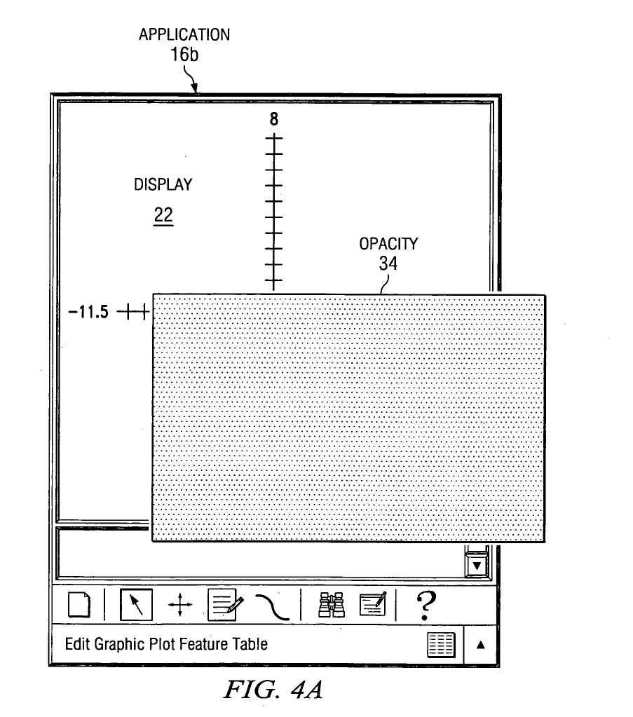

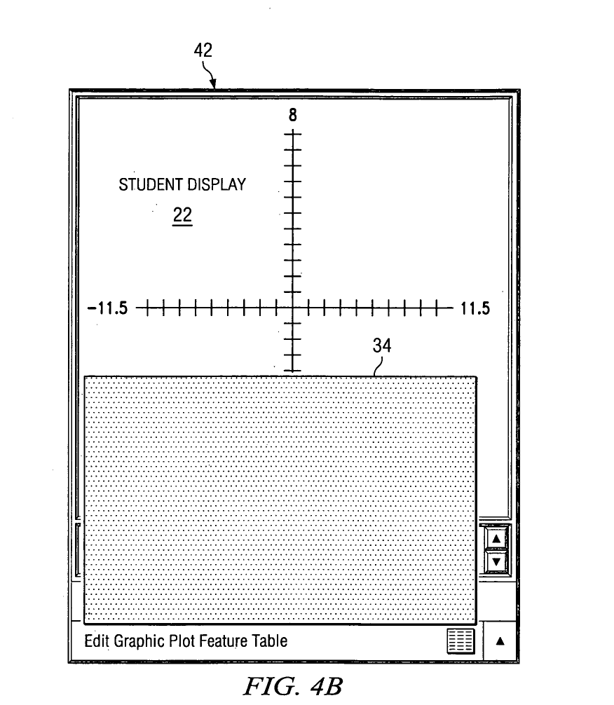

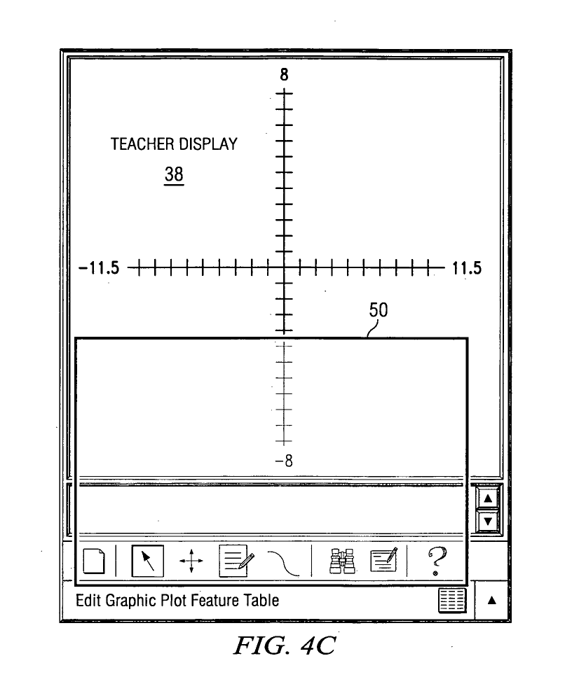

Referring now to FIGS. 4A, 4B, and 4C there is shown another embodiment of the present invention wherein the virtual overlay is not a transparency but as shown is an opacity or an opaque overlay 34. FIG. 4B illustrates the composite image created by the combination of the selected image 16b and the opacity or the opaque overlay 34 as would be viewable at a student or secondary view. Since the composite overlay of FIG. 4B completely obscures portions of the selected image 18, the use of such an opaque overlay would be of limited use without other features of this embodiment. Therefore as will be discussed, there is also a teacher or master view illustrated in FIG. 4C.

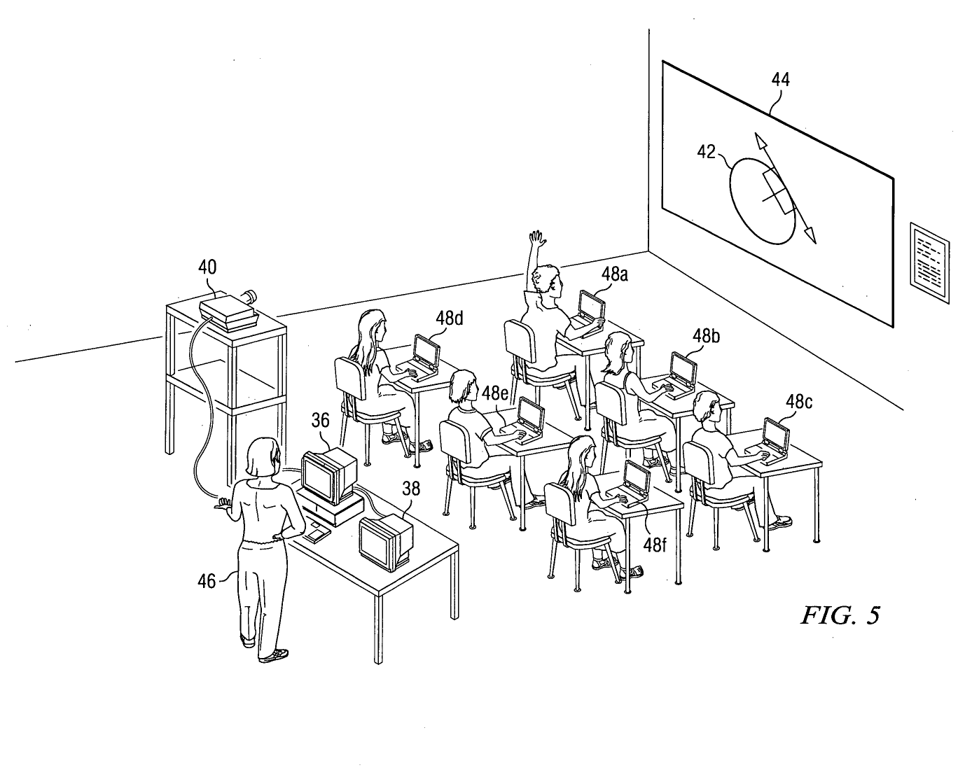

Referring to FIG. 5, there is shown a typical classroom setup that can benefit- from the teachings of the present invention. As shown, FIG. 5 is a block diagram of the classroom arrangement and includes the first computing device 36, such as a PC, or a handheld computer, or other computing device, a master display 38, a projection device 40 also connected to PC 36 for displaying a secondary view such as the image 42 of a tangent to circle illustrated on screen 44. Thus, the instructor or teacher 46 can observe both the master display device 38, (which is typically a direct view device such as a CRT device, an LCD device, or a plasma display device), and the secondary view 42 on screen 44. However, the students at the learning stations 48a-48f can only see the secondary view of the image 42 on screen 44. Alternately the secondary view could be displayed on a front projector device, a rear projection device, including a DLP device, or a direct view device. Therefore, it will be appreciated that the secondary view of the composite image is made up of a selected image and an opaque overlay such as is illustrated in FIG. 4B whereas the master display that is viewable by the instructor 46 will be a composite view as illustrated in FIG. 4C. Thus, as can be seen from FIG. 4C, the master or teacher view or master display 38 does not actually obscure the portion of the selected image but instead simply clearly defines the area that is opaque on the secondary view on screen 44 by means of color tinting or an outline as indicated by the outline borders 50.

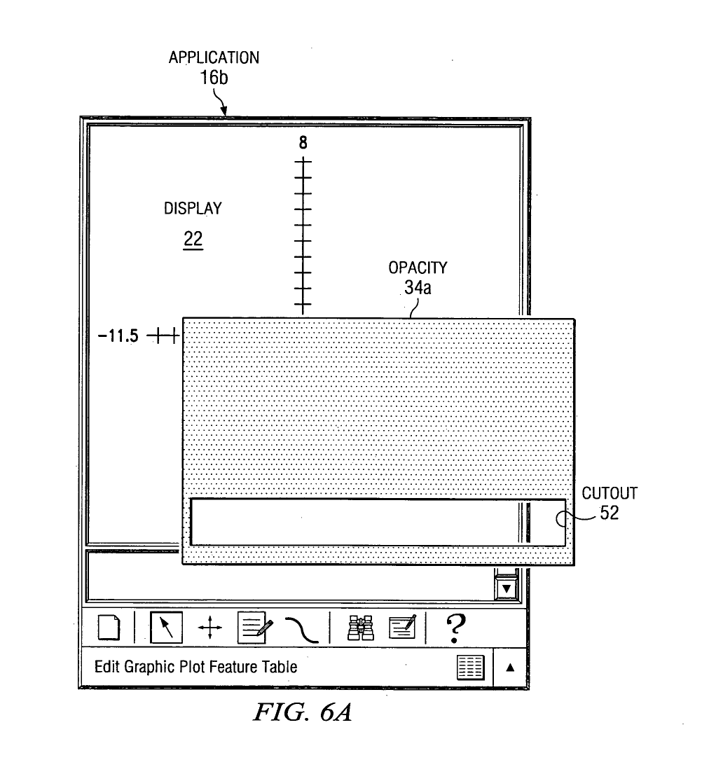

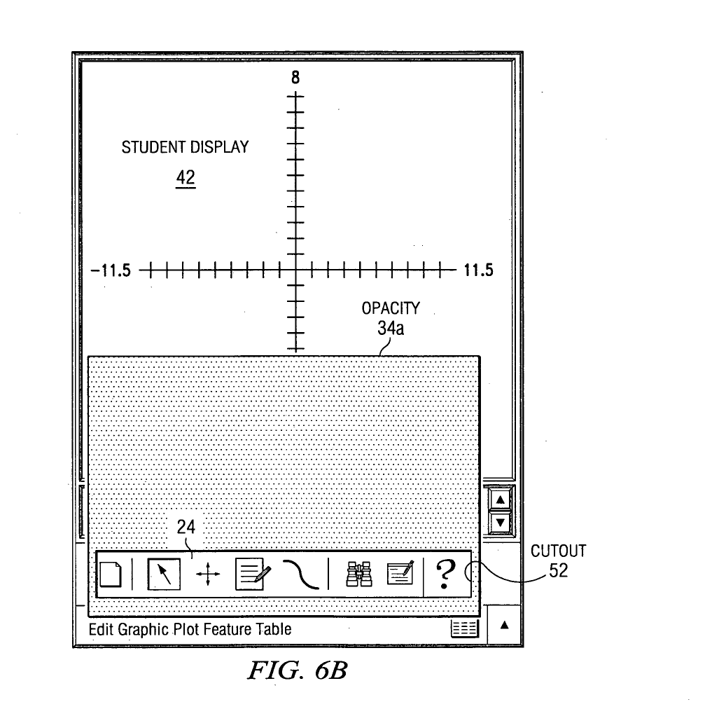

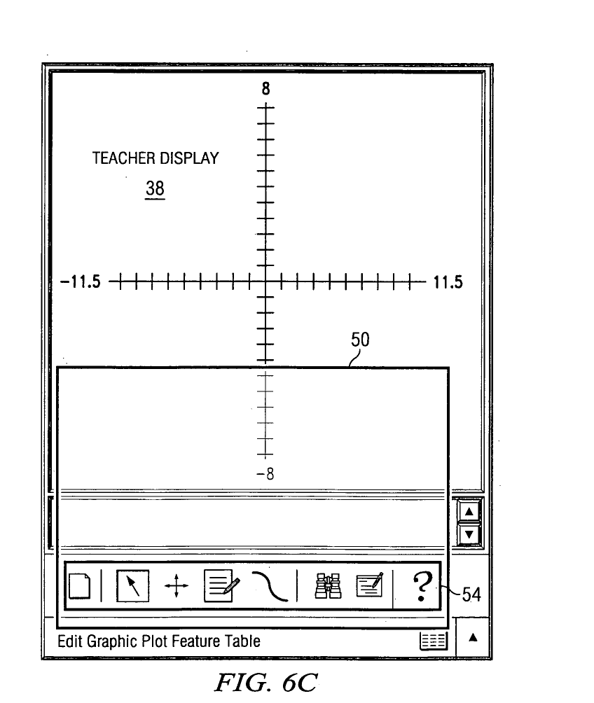

Referring now to FIGS. 6A, 6B, and 6C the teaching technique of using opacity overlays is further described. As shown in the exploded view of FIG. 6A, the opacity overlay 34a now includes a cut out or aperture 52 defined in the opacity overlay 34a. The cut out or aperture 52 was created by the instructor or teacher by a pair of virtual scissors or other means for defining the cut out or aperture area and the cut out is selected to be over a particular portion of the selected view 16c that the teacher wants to reveal or make visible while the remainder of the opacity overlay continues to conceal other portions of the selected image. Thus, as seen in the FIG. 6B, which represents the secondary image with the cut out or aperture 52, the secondary image as seen by the students now displays the tool bar area 24, discussed above with respect to FIGS. 2A and 2B, that is directly below the aperture 52. As shown, the remainder of the portion of the selected view 16b remains obscured. FIG. 6C on the other hand illustrates the master display 38 wherein again the cut out is indicated by boundary lines 54 or could also be indicated by removing the tinting in the area 54. In any event, it is seen that the teacher or instructor display indicates clearly to the instructor what is being displayed on the secondary views. Although not so important in a classroom setup where the teacher has visible access to both the master display 38 with the unobstructed view, and the secondary view on screen 44 since the instructor can simply look at both displays, the concept is important with respect to virtual classrooms where the instructor may be remote from the students and there is not a readily observable secondary view available to the teacher, but a multiplicity of secondary views on the laptop displays or other display devices of the students that may be at a considerable distance from the teacher 46.

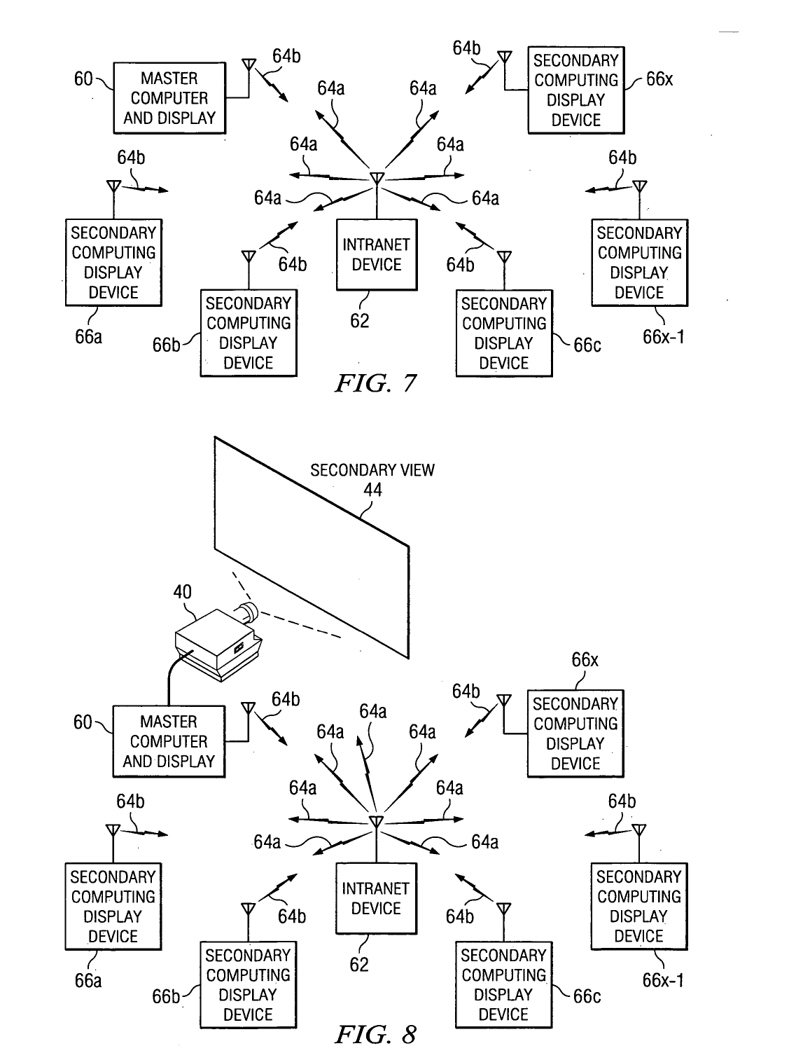

For example, referring to FIG. 7, there is shown a virtual classroom setup including the teacher's master computer and display 60 and an intranet device 62 that sends (arrows 64a) and receives (arrows 64b) signals between both the master computer and display device 60 and a multiplicity of secondary computing display devices 66a-66x controlled and viewed by the students. In the embodiment shown, the devices are shown as being interconnected by wireless techniques, however, it would also be possible to use wired or cable connections. Further, the students may be at individual locations miles apart, at the same classroom but separated from the teacher, or could even be across country. Therefore as shown, in a teaching lesson wherein the set up is similar to that of FIG. 7, it is important that since the instructor or teacher can't see the displays actually being viewed by the students at remote distances, the master display 60 provides some indication of not only the annotations, but the cut out or apertures if opaque overlays are used.

Thus, it is seen that use of the overlays in a teaching situation has two major roles. First, annotations may be added that are completely transparent to the underlying program generating the primary image. Secondary annotations or uses interacting may be intercepted before the interactions make it to the underlying programs. These advantages may be very useful in a network environment. For example, students could use transparencies to annotate a reading passage that is then sent to the teacher. The teacher could overlay a multiplicity of such student transparencies to see patterns of the students' contributions. Also, transparencies could be used to queue the interactions of multiple users rather than forcing them to pass control of an application from one to another.

Referring now to FIG. 8, there is illustrated still another classroom set up. The set up of FIG. 8 is very similar to that of FIG. 7 except that the students at stations 64a -66x may have an individual display but still prefer to watch the larger screen 44 that also contains a secondary view, as provided by projector 40. In this embodiment, the instructor or teacher at station 60 may still have a master view on it's master display, but can also look at the secondary view on the screen 44. Also as shown there may be a cable connection between the master station 60 and projector 40a or the connection could be a wireless connection as indicated by the lightning arrow 66a directed toward receiving antenna 68 connected to the projector 40a.

Therefore, it is seen that using the teachings of the present invention, teaching techniques of the past to be incorporated and used with the modern tools available for teaching today.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the machines, means, methods and steps described in the specification. As one of ordinary skill in the art will readily appreciate from the disclosure of the present invention, machines, means, methods, or steps, presently existing or later to be developed, that perform substantially the same function or achieve substantially the same result as the corresponding embodiments described herein may be utilized according to the present invention. Accordingly, the appended claims are intended to include within their scope such machines, means, methods, or steps.

What is claimed is:

1. A method of annotating a display image the method comprising the steps of:
generating a selected image by a computing device;
generating a virtual image overlay of said selected visual image by said computing device;
displaying said selected image and said virtual overlay to form a composite image; and
altering the appearance of said virtual image overlay by said computing device such that the composite image is changed.

2. The method of claim 1 wherein said selected image is generated by said computing device from digital data provided thereto.

3. The method of claim 2 wherein said digital data for generating said select image is provided by a computer program.

4. The method of claim 1 wherein said virtual image overlay is a virtual transparent overlay and wherein said step of altering of said virtual image overlay by said computing device comprises the step of generating visual indicia on said virtual transparent overlay for annotating said selected image.

5. The method of claim 4 wherein said visual indicia comprises selected shapes having a selected size.

6. The method of claim 5 wherein said selected shapes comprise rectangular and circular shapes.

7. The method of claim 4 wherein said visual indicia comprises selected symbols.

8. The method of claim 7 wherein said selected symbols are selected from the group consisting of arrows, check marks, crosses, hand silhouettes, stars, pointers, underlines, and letters of the alphabet.

9. The method of claim 4 wherein said visible indicia comprises marks and lines formed by free hand.

10. The method of claim 9 wherein a virtual pen having a selected line width and color is used to form said lines and marks.

11. The method of claim 4 wherein said virtual indicia comprises areas of said virtual transparent overlay having a color tint.

12. The method of claim 11 wherein a virtual highlighter having a selected color is used to form said areas having a color tint.

13. The method of claim 4 wherein said virtual transparent overlay comprises at least two virtual transparent overlays.

14. The method of claim 13 wherein each of said at least two virtual transparent overlays is tinted a different color.

15. The method of claim 1 wherein said virtual image overlay is a virtual opaque overlay covering selected portions of said selected image.

16. The method of claim 15 wherein said virtual opaque overlay defines at least one opening such that the portion of the selected image under said at least one defined opening is visible.

17. The method of claim 1 wherein a first portion of said virtual image overlay comprises a virtual transparent portion adapted for including annotations and a second portion of said virtual image overlay comprises a virtual opaque overlay portion.

18. The method of claim 17 wherein said virtual opaque overlay portion defines at least one opening therein such that the portion of the selected image under said virtual opaque overlay is visible.

19. The method of claim 1 wherein said step of displaying comprises the step of receiving digital image signals at a display device; displaying an image representing said received digital image signals and wherein said received digital image signals are generated by said computing device and represent said composite image.

20. The method of claim 19 wherein said computing device comprises a master computing device having primary control of said display device and at least one secondary computing device for only altering the appearance of said image overlay when permitted by said master computing device.
